(19) United States
(12) Patent Application Publication
(10) Pub. No.: US 2012/0268702 A1
(43) Pub. Date: Oct. 25, 2012

(54) LIQUID CRYSTAL DISPLAY DEVICE

(75) Inventors: Yasuo IMANISHI, Katano (JP); Hidehiro Sonoda, Mobara (JP); Noboru Kunimatsu, Chiba (JP); Yasushi Tomioka, Hitachinaka (JP); Masaki Matsumori, Tokai (JP)

(73) Assignee: Hitachi Displays, Ltd.

(21) Appl. No.: 13/442,935

(22) Filed: Apr. 10, 2012

(30) Foreign Application Priority Data
Apr. 22, 2011 (JP) 2011-095970

(51) Int. Cl. G02F 1/1337

(52) U.S. Cl. 349/124

(57) ABSTRACT

Provided is a high quality liquid crystal display device adapted to suppress scraping of alignment film and prevent micro light spot fault. The liquid crystal display device comprises: a plurality of columnar spacers and a first alignment film disposed over a first substrate; an insulation film disposed over a second substrate; and a second alignment film disposed over the insulation layer; receiving pedestals for the columnar spacers, wherein: the second alignment film is not formed over the central portion of each of the receiving pedestals; and around the outer peripheral portion of each receiving pedestal, the second alignment film has an inclined thickness distribution which is such that the thickness thereof increases gradually from the central portion to the outside position of the receiving pedestal.

### CLAIM OF PRIORITY

The present application claims priority from Japanese Patent Application JP 2011-095970 filed on Apr. 22, 2011, the content of which is hereby incorporated by reference into this application.

### BACKGROUND OF THE INVENTION

1. Field of the Invention

The present invention relates to a stable liquid crystal display device of high image quality adapted to prevent generation of micro light spots.

2. Description of the Related Art

Use of liquid crystal display devices has extended due to their advantageous features of high display quality, thinness, light weight, and low power consumption. For example, they are used for portable monitors such as mobile phone monitors and digital still camera monitors, and also for desk top personal computer monitors, monitors for printing and designing, monitors for medical equipment, liquid crystal televisions, etc. Along with the extension of application use, liquid crystal display devices are desired to have higher resolution and higher quality. In particular, higher luminance and lower consumption power is strongly demanded to be achieved by increasing the transmittance. Further, along with the popularization of liquid crystal display devices, there is also a strong demand for cost reduction.

Usually, a liquid crystal display device displays an image by applying an electric field on the liquid crystal molecules in the liquid crystal layer put between a pair of substrates. The alignment direction of the liquid crystal molecules thus changes, thereby changing the optical property of the liquid crystal layer to display the image. The alignment direction of the liquid crystal molecules of when no electric field is applied is determined by the alignment films, which are a polyimide thin film whose surface has been subjected to a rubbing treatment.

Conventionally, in an active driven liquid crystal display device having a switching device such as a thin film transistor (TFT) on every pixel, an electrode is provided to each of the two substrates containing a liquid crystal layer therebetween, and images are displayed by applying an electric field in a direction substantially vertical to the substrate faces. In other words, the device is configured to apply a so-called vertical electric field to the liquid crystal layer to display an image utilizing the optical rotation of the liquid crystal molecules forming the liquid crystal layer. Typical known liquid crystal display devices using a vertical electric field are the twisted nematic (TN) type and the vertical alignment (VA) type.

One major problem of TN and VA liquid crystal display devices is that the view angle is narrow. As display types for attaining a wide view angle, the IPS (In-Plane Switching) type and the FFS (Fringe-Field Switching) type are known.

The IPS type and the FFS type are display types of a so-called horizontal electric field type, in which comb-shaped electrodes are formed on one of the two substrates, and a generated electric field has a component substantially parallel to the substrate faces. Liquid crystal molecules forming the liquid crystal layer are rotated in planes substantially parallel to the substrate so that an image is displayed using birefringence of the liquid crystal layer. Compared with the conventional TN type, these types are advantageous in that the view angle is wide and the load capacitance is low because of the in-plain switching of liquid crystal molecules. They are expected to be the new liquid crystal display devices that would replace the TN types, and technologies concerning those types are rapidly progressing in recent years.

A liquid crystal display device controls the orientation of liquid crystal molecules in the liquid crystal layer according to presence/absence of an electric field. To be more specific, the upper and lower polarization plates outside the liquid crystal layer are disposed such that the plates are completely orthogonal to each other, and light-dark contrast is formed by generating phase difference by the orientation of liquid crystal molecules in the liquid crystal layer. A polymeric thin film called an alignment film is formed on the surface of substrates in order to control the orientation when an electric field is not applied to the liquid crystals. The liquid crystal molecules are oriented in the array direction of the polymer by the intermolecular interaction due to Van der Waals' force between polymer chains and liquid crystal molecules at the boundary.

This effect is also referred to as provision of alignment control force or liquid crystal alignment ability, or alignment treatment. Polyimide is often used for the alignment film of liquid crystal displays. To form an alignment film, polyamide acid as the precursor of polyimide is dissolved into a solvent, and the solution is coated over a substrate by spin coating or printing. The substrate is heated at a high temperature over 200° C. to thereby remove the solvent and cause imidizing ring-closing reaction of the polyamide acid to form polyimide. The film would be a thin film with thickness of about 100 nm. Rubbing the surface of the polyimide thin film with a rubbing cloth in a predetermined direction, the polyimide polymer chains at the surface will be oriented in that direction, and the surface polymer can have high anisotropy.

However, in rubbing treatments, static electricity or contaminants may be generated by the rubbing, and also the rubbing may be performed non-uniformly due to unevenness of the substrate surface. An optical alignment method is beginning to be employed which controls molecular orientation using polarized light so that contact with a rubbing cloth is unnecessary. In order to keep the distance between upper and lower alignment films constant, a member called a spacer is used. Polymer beads and polymer films had been conventionally used as spacers. The method used recently is such that columnar spacers are previously formed on the alignment film on one side, and pedestals for receiving the columnar spacers are formed at positions opposing the columnar spacers. With such spacers, the thickness of the liquid crystal layer of each pixel (cell gap) can be made uniform, which enables to obtain a liquid crystal display device having high image quality.

When such columnar spacers and receiving pedestals are used, alignment films are coated over the spacers and pedestals before they are assembled to form liquid crystal cells. Since an alignment film exists at the contact area between the columnar spacer and the receiving pedestal, for reasons such as vibration upon packaging or transportation of the liquid crystal display device, or warpage of the liquid crystal display device caused by a change in its usage temperature circumstance, the contact and friction between the columnar spacer and receiving pedestal the may scrape the film. The scraped films would drift in the liquid crystal layer, whereby generating micro orientation-fault light spots. The scraped films particularly cause a significant problem regarding the display quality at portions displaying low luminance light (low gradation image) such as black color.

In view of this, there have been proposed methods such as a method of reducing the thickness of the alignment film on a columnar spacer by adapting the shape thereof (JP-A No. 2010-091841), a method of reducing the thickness of the alignment film on the receiving pedestal by adapting the shape thereof (JP-A No. 2010-152188), a method of reducing the thickness of the alignment film on a receiving pedestal by forming a trench along the outer periphery thereof (JP-A No. 2010-164750), and a method in which a minute protrusion is formed on the surface of a pedestal so that the protrusion bites into the columnar spacer (JP-A No. 2010-181786).

These methods, however, cannot completely suppress generation of scraped films and cannot prevent micro light spot failure.

### SUMMARY OF THE INVENTION

The present invention intends to provide a liquid crystal display device of higher quality that can suppress scraping of an alignment film and prevent micro light spot failure.

The present invention for solving the above problem has the following main features.

(1) A liquid crystal display device comprises: a first substrate; a second substrate disposed in facing relation to the first substrate; a liquid crystal material disposed between the first substrate and the second substrate; a plurality of columnar spacers and a first alignment film disposed over the first substrate; an insulation film disposed over the second substrate; and a second alignment film disposed over the insulation layer; the liquid crystal display device further comprising: receiving pedestals for the columnar spacers, the receiving pedestals being disposed between the insulation layer and the liquid crystal material at positions opposing the columnar spacers, and being formed of a material different from both the insulation layer and the second alignment film, wherein: the second alignment film is not formed over the central portion of each of the receiving pedestals; and around the outer peripheral portion of each receiving pedestal, the second alignment film has an inclined thickness distribution which is such that the thickness thereof increases gradually from the central portion to the outside position of the receiving pedestal.

(2) A liquid crystal display device comprising: a first substrate; a second substrate disposed in facing relation to the first substrate; a liquid crystal material disposed between the first substrate and the second substrate; a plurality of columnar spacers and a first alignment film disposed over the first substrate; an insulation layer disposed over the second substrate; and a second alignment film disposed over the insulation layer; wherein: the second alignment film is not formed at portions of the first substrate opposing the columnar spacers; the area of the portions opposing the columnar spacers is larger than the area of the top ends of the columnar spacers; the second alignment film around the periphery of the opposing portion has an inclined thickness distribution such that the thickness of the film increases gradually toward the outside direction; and the second alignment film around the periphery of the opposing portion has a thickness distribution also in the in-plane direction of the substrate.

An aspect of the present invention provides a structure in which a liquid crystal alignment film is not deposited on positions opposing the columnar spacers, which are disposed to keep a constant distance between the upper and lower substrates of the liquid crystal display device. Scraping of the alignment film at the position opposing the columnar spacer caused by contact and lateral displacement can be restricted. As a result, one of the display failures, micro light spots can be prevented from generating.

### BRIEF DESCRIPTION OF THE DRAWINGS

FIG. 1A is a schematic view of an element structure near a columnar spacer and a receiving pedestal according to an embodiment of the invention;

FIG. 1B is a schematic view of an element structure near a columnar spacer and a receiving pedestal according to another embodiment of the invention;

FIG. 2A is a schematic view of an element structure near a columnar spacer and a receiving pedestal according to another embodiment of the invention;

FIG. 2B is a schematic view of an element structure near a columnar spacer and a receiving pedestal according to another embodiment of the invention;

FIG. 3A is a schematic plan view of an element structure of a receiving pedestal according to another embodiment of the invention;

FIG. 3B is a schematic cross sectional view of the element structure of the receiving pedestal shown in FIG. 3A taken along line A-A′;

FIG. 3C is a schematic cross sectional view of the element structure of the receiving pedestal shown in FIG. 3A taken along line B-B′;

FIG. 4A is a schematic plan view of an element structure of a receiving pedestal according to another embodiment of the invention;

FIG. 4B is a schematic cross sectional view of the element structure of the receiving pedestal shown in FIG. 4A taken along line A-A′;

FIG. 4C is a schematic cross sectional view of the element structure of the receiving pedestal shown in FIG. 4A taken along line C-C′;

FIG. 5 is an explanatory flow for manufacturing procedures of a liquid crystal display device according to the invention;

FIG. 6 is a schematic block diagram showing an example for a schematic configuration of a liquid crystal display device according to the invention;

FIG. 7 is a schematic circuit diagram showing an example of a circuit configuration of one pixel of a liquid crystal display panel;

FIG. 8 is a schematic plan view showing an example of a schematic configuration of a liquid crystal display panel;

FIG. 9 is a cross sectional view taken along A-A′ in

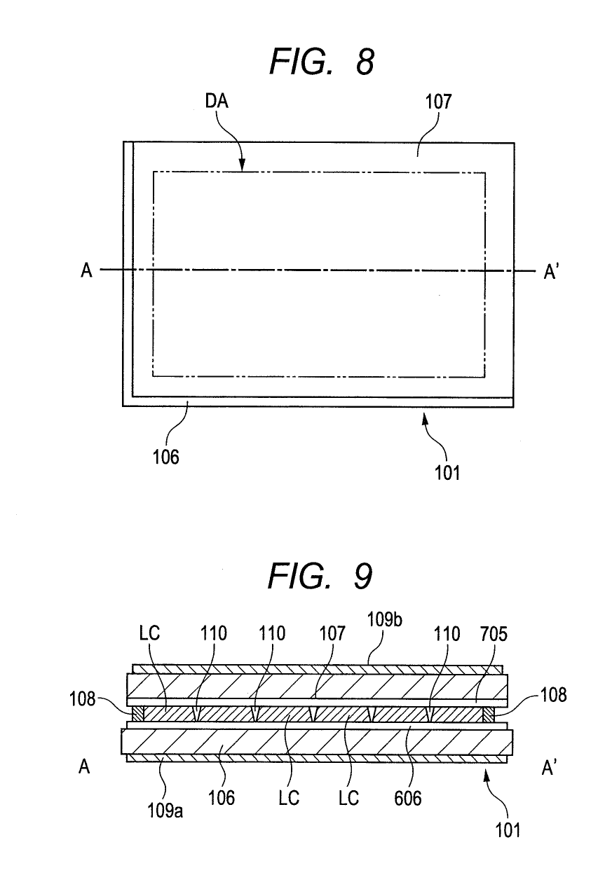

FIG. 8;

FIG. 10 is a schematic view showing an example of a schematic configuration of an IPS liquid crystal display panel according to the invention;

FIG. 11 is a schematic view showing an example of a schematic configuration of a FFS liquid crystal display panel according to the invention;

FIG. 12 is a schematic view showing an example of a schematic configuration of a VA liquid crystal display panel according to the invention;

FIG. 13A is a plan view of a schematic structure of a receiving pedestal used in Embodiment 1 of the invention;

FIG. 13B is a cross sectional view of the schematic structure of a receiving pedestal used in Embodiment 1 taken along line A-A′;

FIG. 14A to 14E are schematic views of a cross sectional structure showing receiving pedestals and alignment films obtained in Embodiment 1 of the invention;

FIG. 15A is a structural plan view of a columnar spacer used in Embodiment 1 of the invention;

FIG. 15B is a cross sectional view of the columnar spacer in FIG. 15A taken along line A-A′;

FIG. 16 shows Table 1 showing the test result of an IPS system;

FIG. 17 shows Table 2 showing the test result of a FFS system;

FIG. 18 shows Table 3 showing the test result of a VA system;

FIG. 19 is an arrangement view of a receiving pedestal and a photomask used in Embodiment 2 of the invention;

FIG. 20A shows Table 4 showing the effect of Embodiment 2 with radius 1 μm;

FIG. 20B shows Table 5 showing the effect of Embodiment 2 with radius 2 μm;

FIG. 20C shows Table 6 showing the effect of Embodiment 2 with radius 3 μm;

FIG. 21A is a cross sectional view near a columnar spacer according to Embodiment 3 with alignment film at the contact portion; and

FIG. 21B is a cross sectional view near a columnar spacer according to Embodiment 3 without alignment film at the contact portion;

### DESCRIPTION OF THE PREFERRED EMBODIMENTS

The present invention will be described in details by way of preferred embodiments (examples) with reference to the drawings. In the drawings for explaining the embodiments and actual examples of the invention, parts having identical functions are assigned with the same reference numeral, and repeated descriptions thereof are omitted.

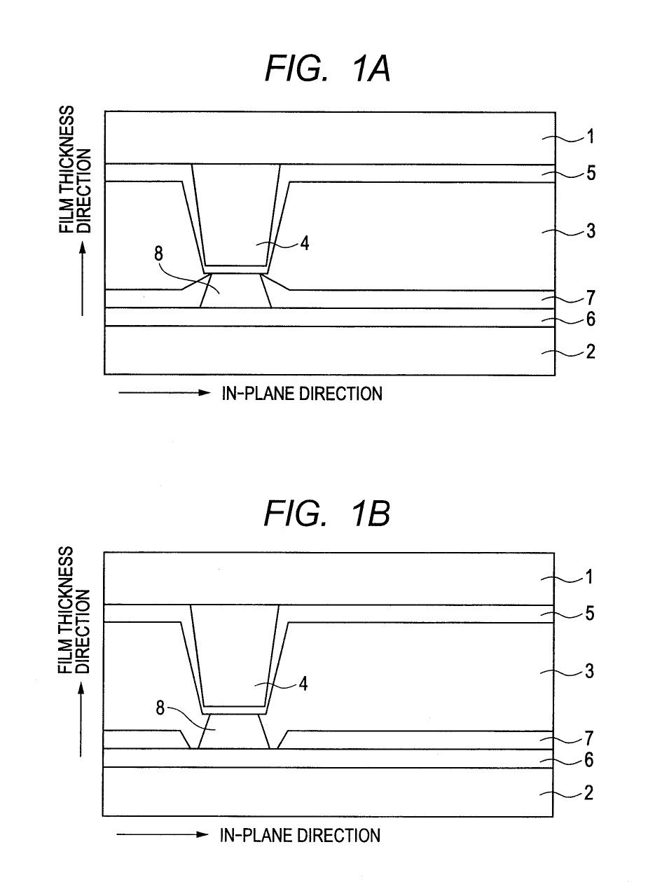

First, a basic element structure of a liquid crystal display device according to the invention is to be described with reference to drawings and tables. FIG. 1A shows an example of a cross section of a partial element structure of the liquid crystal display device according to the invention.

The liquid crystal display device of the invention has a first substrate 1; a second substrate 2 disposed in facing relation to the first substrate 1; a liquid crystal material 3 disposed between the first substrate 1 and the second substrate 2; a plurality of columnar spacers 4 and a first alignment film 5 disposed over the first substrate 1; an insulation film 6 disposed over the second substrate 2; a second alignment film 7 disposed over the insulation layer 6; and receiving pedestals 8 disposed between the insulation layer 6 and the first alignment film 5 at positions opposing the columnar spacers, the receiving pedestals 8 being formed of a material different from both the insulation layer 6 and the second alignment film 7.

In this structure, the second alignment film 7 is not formed at the central portion of a pedestal 8, and the thickness of the second alignment film 7 surrounding the outer periphery of the receiving pedestal 8 has an inclined thickness distribution such that the thickness increases gradually from the central portion to the outside. The thickness of the first alignment film 5 over the first substrate 1 is not here defined particularly.

FIG. 1B shows another example of a cross section of a partial element structure of a liquid crystal display device according to the present invention. The configuration of the members is basically identical with that of FIG. 1A. However, the area at which the second alignment film 7 is not formed is extended to the outside of the receiving pedestal 8 from the central portion thereof. Around the area, the second alignment film 7 has an inclined thickness distribution such that the thickness thereof increases gradually from the central portion to the outside.

Although not illustrated, the second alignment film 7 may also be formed such that the area at which the film is not formed extends to an intermediate position between the positions in FIG. 1A and FIG. 1B, that is, to a midway position on the tapered portion or a midway position on the planar portion of the receiving pedestal 8. However, it is preferred that the alignment film 7 is not formed over the surface at which the columnar spacer 4 and the receiving pedestal 8 contact with each other.

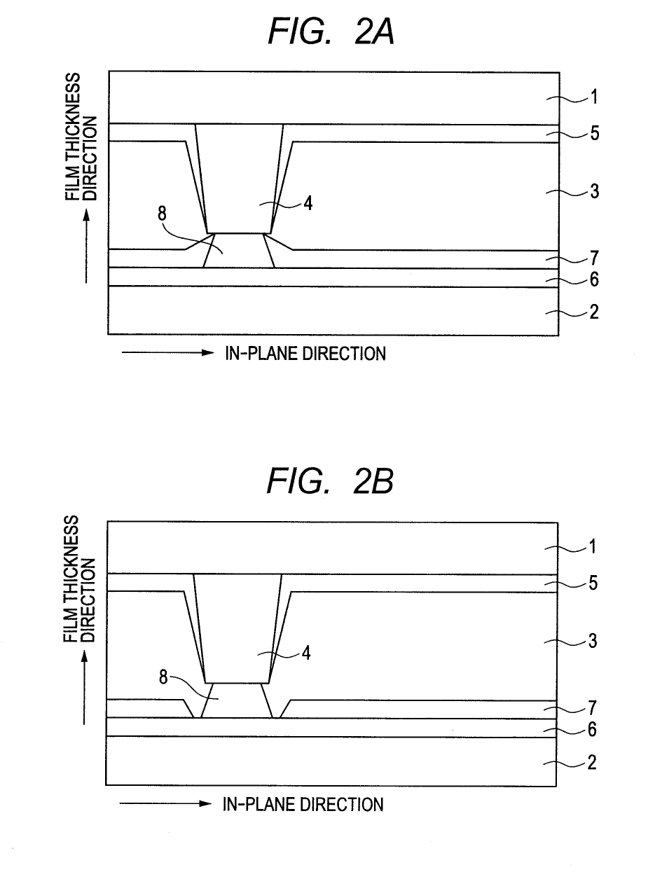

FIG. 2A shows another example for a cross section of a partial element structure of a liquid crystal display device according to the invention. The configuration of the members is basically identical with that of FIG. 1A. However, the thickness of the first alignment film 5 of the columnar spacer 4 has an inclined thickness distribution in which the thickness increases gradually from the central portion to the outside of the columnar spacer. In this case, since both of the flat portion of the columnar spacer 4 and the flat portion of the receiving pedestal 8 are in contact at a surface where the alignment film is not formed, there is no possibility that the first alignment film 5 or the second alignment film 7 is pealed at the contact portion by friction, for example, due to bonding of the upper and lower substrates and warp of the upper and lower substrates by vibrations, or impacts after molding as the liquid crystal display device or the change of the working temperature circumstance.

FIG. 2B shows another example of a cross section for the partial device structure of the liquid crystal display device according to the invention. While the configuration of basic members is identical with that of FIG. 1B, the first alignment film 5 over the columnar spacer 4 has an inclined thickness distribution that the thickness increases gradually from the central portion to the outside of the columnar spacer 4. In this structure, since the second alignment film 7 is not formed to the outside of the receiving pedestal 8, even if the position of the columnar spacer 4 and that of the receiving pedestal 8 are somewhat displaced within the direction of the plane, there is lesser possibility that the alignment film 7 is peeled by friction.

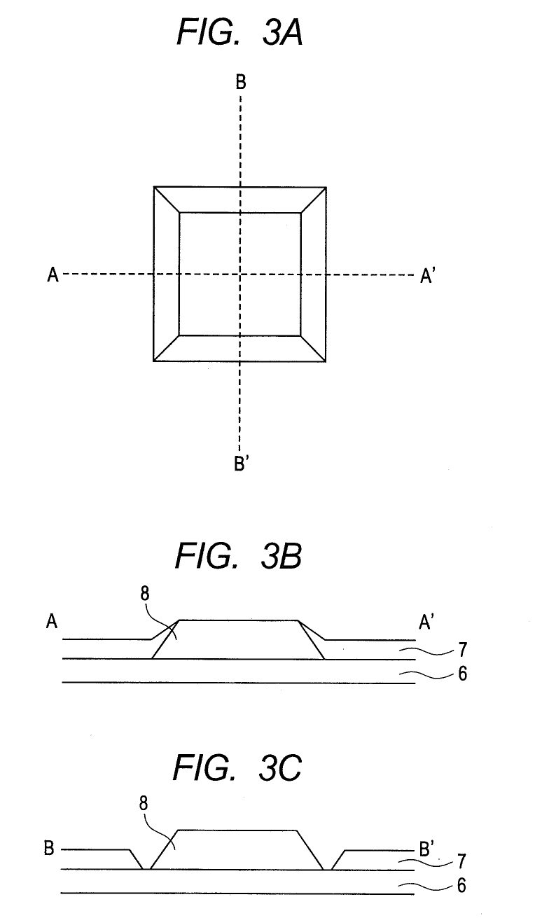

FIG. 3 shows a plan view and another example of a cross sectional view of a receiving pedestal 8 in another liquid crystal display device according to the present invention.

FIG. 3A shows a plan view of the receiving pedestal 8. A receiving pedestal having a square shape is here shown as an example. The receiving pedestal 8 has a flat central portion and four tapered side faces. FIG. 3B shows the cross section along the plane A-A′ of FIG. 3A. In this cross section, the second alignment film 7 is not formed at the central portion. At the tapered portions, the second alignment film 7 having an inclined thickness distribution such that the thickness thereof increases gradually from the central portion to the outside is formed in the same manner in FIG. 1A. FIG. 3C shows the cross section along the plane B-B′ in FIG. 3A.

In this cross section, as with in FIG. 1B, the area at which the second alignment film 7 is not formed extends from the central portion of the receiving pedestal 8 to somewhat outside thereof. Around the area, the alignment film 7 is formed with an inclined thickness distribution such that the thickness thereof increases gradually from the central portion to the outside. That is, an area in which the alignment film 7 is formed with the inclined thickness distribution may exist partially on the substrate faces. While a structure in which the alignment film 7 is formed over specific tapered portions and not over the other tapered portions is described here as an example, a structure in which the alignment film 7 is formed over a partial area of a tapered portion is also possible. Further, as shown in FIG. 3A showing a plan view of a receiving pedestal 8, the part in which the alignment film 7 has the inclined thickness distribution has a shape that gets smaller toward the central portion and larger toward the outside direction from the receiving pedestal.

If the area having the inclined thickness distribution has a distribution within the substrate faces, in the alignment film formation process, the alignment film solution on the central portion of the receiving pedestal 8 will be drawn due to the difference of surface tension, which is effective for preventing the alignment film from remaining on the central portion.

Further, if the area having the inclined thickness distribution has a distribution within the substrate faces, and the distribution has a shape that gets smaller toward the central portion of the receiving pedestal 8 and larger toward the outside direction therefrom, it is further effective for preventing the alignment film from remaining on the central portion.

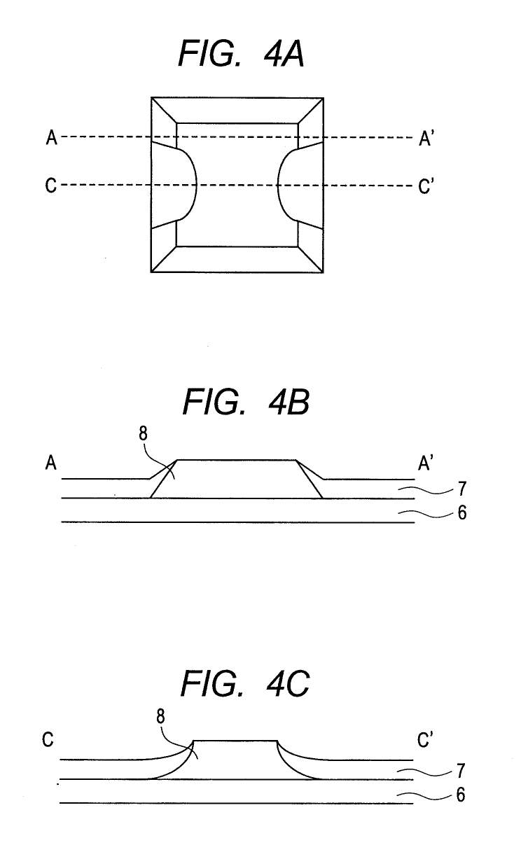

FIG. 4 shows a plan view and cross sectional views of a receiving pedestal 8 in another example of a liquid crystal display device according to the present invention. FIG. 4A shows a plan view of the receiving pedestal 8. A receiving pedestal basically having a square shape and two recessed positions is here shown as an example. FIG. 4B shows the cross section along the plane A-A′ in FIG. 4A. In this cross section, the second alignment film 7 is not formed at the central portion as with in FIG. 1A, and the alignment film 7 is formed over the tapered portions with an inclined thickness distribution that increases gradually from the central portion to the outside. FIG. 4C shows the cross section along the plane C-C′ in FIG. 4A. In this cross section, the section traverses the center of the recessed portions, and the inclined thickness distribution of the alignment film 7 is steeper than that in the A-A′ section in FIG. 4A.

As in this example, when the area in which the second alignment film is formed with the inclined thickness distribution is formed in the recessed portion(s) rather than in the central portion of the receiving pedestal, solution can be more easily disconnected between the central portion and the recessed portions of the receiving pedestal 8 during formation of the alignment film. The solution on the central portion would be drawn from the tapered portions that do not have such recessed portions due to the difference of surface tension, which is effective for suppressing an alignment film remaining in the central portion of the receiving pedestal 8. The essence is to provide a route and difference of surface tension by which a solution for forming an alignment film supplied over the central portion of the receiving pedestal 8 can be rapidly drawn and removed to the outside of the receiving pedestal 8.

Further, while a case where the planer shape of the receiving pedestal 8 is square is shown here as an example, its planar shape may be rectangular, linear, or polygonal. It may as well be a circular or elliptic shape. Furthermore, it may be of a shape having a plurality of concave and/or convex portions. Although the cross sectional shape of the receiving pedestal 8 is preferably forward tapered, it may be vertical or reverse tapered.

For the material of the receiving pedestals 8, while various materials such as Si, SiO₂, Al₂O₃, organic resin, inorganic resin can be used, a material having a certain electric conductivity is desirable in view of preventing the coating of the alignment film 7 from being uneven due to static electricity.

For example, it may be selected from various metal materials, and in order to reduce manufacture cost, the material may be made of one or combination of a plurality of metals in the group of Al, Cu, Ag, Cr, Mo, Ni, and W. Another usable material having electric conductivity are various transparent conductors, and the material may be formed of a transparent conductor such as ITO, IZO, ITZO, ZnO, SnO₂ in order to reduce the manufacturing cost. It is particularly desirable to employ ITO which is used as the transparent electrodes in liquid crystal display devices in order to reduce the manufacturing cost.

Whether the first alignment film 5 or the second alignment film 7 is formed with a desired thickness distribution or not in a liquid crystal display device according to the present invention can be confirmed by the following method. At a stage where the device has been manufactured up to the alignment films, the surface or the cross section of the alignment film is observed by SEM (scanning electron microscope), or by examining the element distribution or concentration by EDS, EDX (energy dispersive X-ray spectrometry) combined with SEM, thereby detecting the presence/absence and thickness of the alignment film.

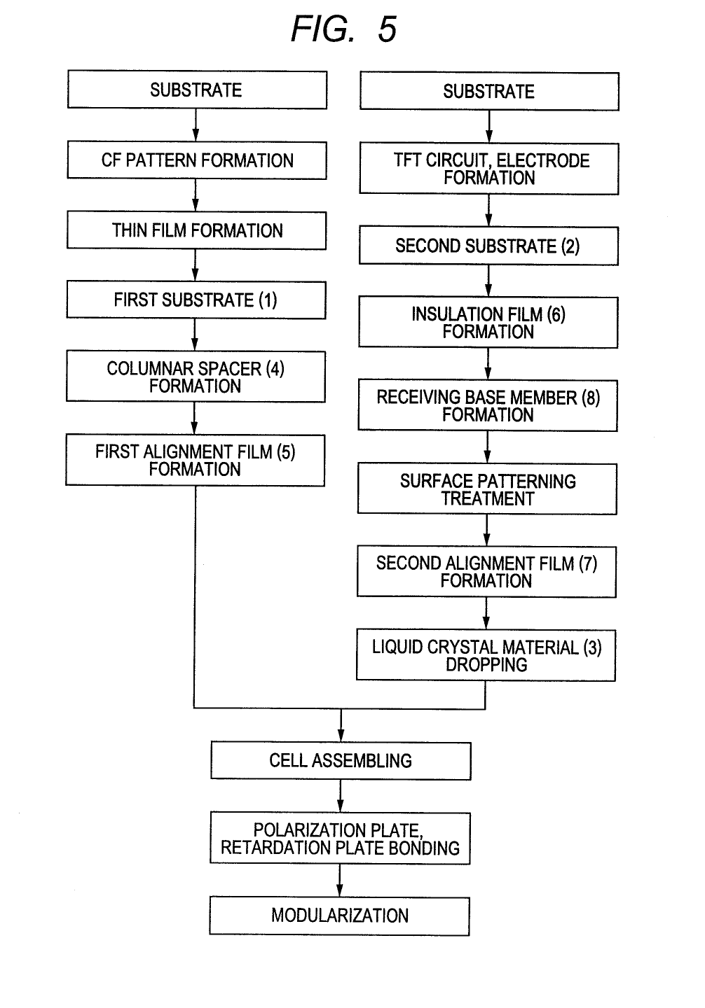

Next, manufacturing process for a liquid crystal device according to the present invention will be described with reference to drawings and tables. FIG. 5 shows an example of a manufacturing process flow for a liquid crystal display device according to the present invention. The substrates may be made of non-alkali glass whose surface is beforehand polished and cleaned. Combination of usual borosilicate glass, plastic, and thin metal sheets, or an optical structure that guides light emitted from a light source to light the liquid crystal display device may also be used as appropriate. However, at least the substrate on the display side needs to be a transparent substrate. A set of two substrates, a substrate for the first substrate and a substrate for the second substrate are prepared.

The first substrate is made through thin film formation processes such as color filter (CF) pattern formation, planarizing film formation, or black matrix formation, or transparent electrode formation. Columnar spacers 4 made of photosensitive resin are formed over the first substrate 1. The height is determined such that the columnar spacers are sufficient as spacers for liquid crystal cells: for example, the height is within a range of 1 μm to 10 μm, and preferably, within a range of 3 μm to 5 μm. Their in-plane width is preferably equal to or greater than the width of the opposing receiving pedestal 8: for example, from 1 μm to 30 μm, and more preferably within a range of 8 μm to 20 μm.

The planar shape of the columnar spacer 4 may be square, rectangle, polygon, circle, or ellipse. Further, the columnar spacer may be shaped to have a plurality of concave and convex portions. Further, a cross sectional shape of the columnar spacer 4 is preferably tapered forward but it may be vertical or tapered reversely. The first alignment film 5 is formed over the column spacers 4. The material for the alignment film can be selected from known various polymer materials, typically polyimide.

First, a polyamide acid as a precursor of the aimed polyimide is dissolved into a solvent to prepare a solution. Then, the solution is coated over an underlying substrate on which the alignment film is to be formed by a wet process such as spin coating, flexographic printing, ink jet printing, etc. The coated solution is preliminarily dried so that the thickness of the solution would not vary and the planarity would not be disturbed remarkably due to the surface tension or the unevenness of the underlying layer. In such a state, the temperature of the substrate is increased to a high temperature and the molecular structure of the polyamide acid is thermally changed for imidization baking. The film surface is then provided with an alignment function by rubbing or light. Thus, the first alignment film 5 is formed.

The second substrate 2 is formed by performing processes such as formation of TFT circuits, electrodes on the underlying substrate for the second substrate 2. The insulation layer 6 is formed thereover. The material for the insulation layer 6 can be selected from various dielectric materials: for example, from SiN, SiO₂, organic resin, etc. Although not illustrated, transparent electrodes are formed thereover and patterned only over the pixel portions, but detailed description therefore is omitted. Receiving pedestals 8 are formed thereover. The details of the receiving pedestals 8 are as described above in the preceding section.

Then, a surface patterning treatment is applied so that the second alignment film 7 would not be formed on the central portion of the receiving pedestals 8. Examples of the surface patterning treatment are: (1) a method in which one molecular layer of fluoro alkyl silane is disposed over the surface after the surface is cleaned, and the area of the surface excluding the receiving pedestals 8 is selectively irradiated with UV-light or oxygen plasma using a photomask so as to remove the fluoro alkyl silane; (2) a method in which a liquid repellent silane coupling agent is coated over the surface after the surface is cleaned, and the area of the surface excluding the receiving pedestals 8 is selectively irradiated with UV-light or oxygen plasma using a photomask so as to remove the silane coupling agent; and (3) a method of forming receiving pedestals 8 that are liquid repellent themselves using a substance such as a fluorine-containing photoresist, or forming a liquid repellent surface coat layer over the receiving pedestals 8 using such substance.

The in-plane pattern of the photomask defines the in-plane distribution of the liquid repellency over the surface, and the edge of the pattern can be sharpened or dulled by adjusting the conditions of UV light irradiation. Alternatively, a thin organic film or thin ITO film may be formed as the uppermost layer of the receiving pedestals 8, and the surface may be rendered hydrophilic by an oxygen plasma treatment or rendered hydrophobic by a CF₄ plasma treatment to thereby control the deposition condition of the alignment film 7. Thus, with a receiving pedestal 8 on the center, areas of different surface liquid repellency can be formed. The second alignment film 7 is formed thereover in a manner similar to that for the first alignment film 5.

Since areas of different liquid repellency are formed on the surface of the underlying layer, for example when polyimide is used as the alignment film, polyamide acid solution as the precursor of the polyimide would be repelled from the receiving pedestal 8 upon its coating step, and also in the drying step, the solution would be transferred to the hydrophilic surface from the liquid repellent surface as the volume of the solution decreases. As a result, there would be no remaining second alignment film 2 on the receiving pedestals 8 when the solution has been finally imidized and dried. However, if the manufacturing conditions are incorrect, liquid droplets of the polyamide acid solution may remain on the receiving pedestal 8 and be dried thereon. An alignment function is provided to the thus formed second alignment film 7 as well.

Next, the liquid crystal material 3 is dropped over the second alignment film 7, and the two substrates having the first and second alignment films 5 and 7 are bonded to assemble cells. For the liquid crystal material and the bonding resin used herein, those used for manufacturing usual liquid crystal display devices can be utilized. The liquid crystals may also be vacuum-sealed after assembling the cells. After that, optical films such as a polarizing plate and a phase retardation plate are bonded, and members such as a backlight, a driving circuit power source, a frame, and an antireflection film are combined to form a module, and then joined with accessory parts, a liquid crystal display device can be completed.

Next, description is given for a liquid crystal display device having a high-quality alignment film that is formed using an alignment film formation solvent according to the present invention.

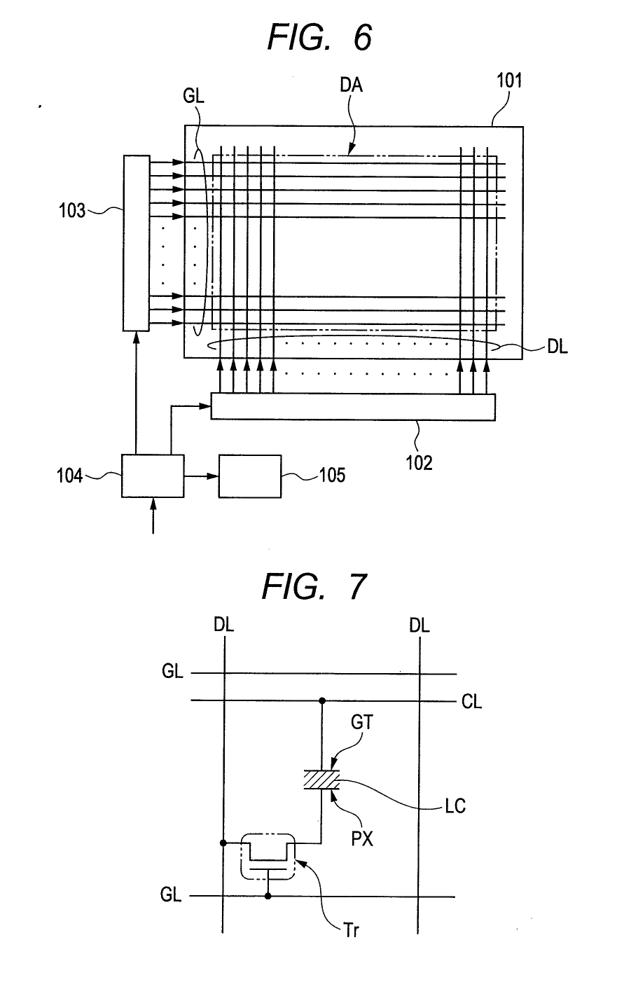

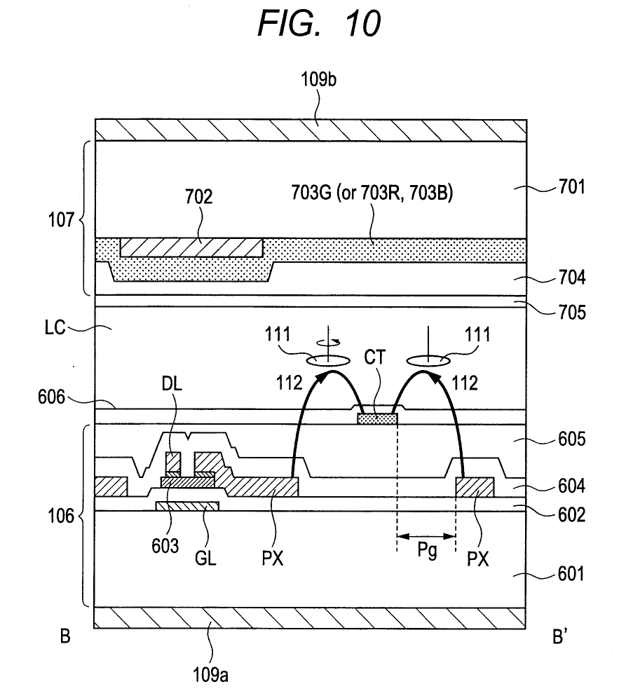

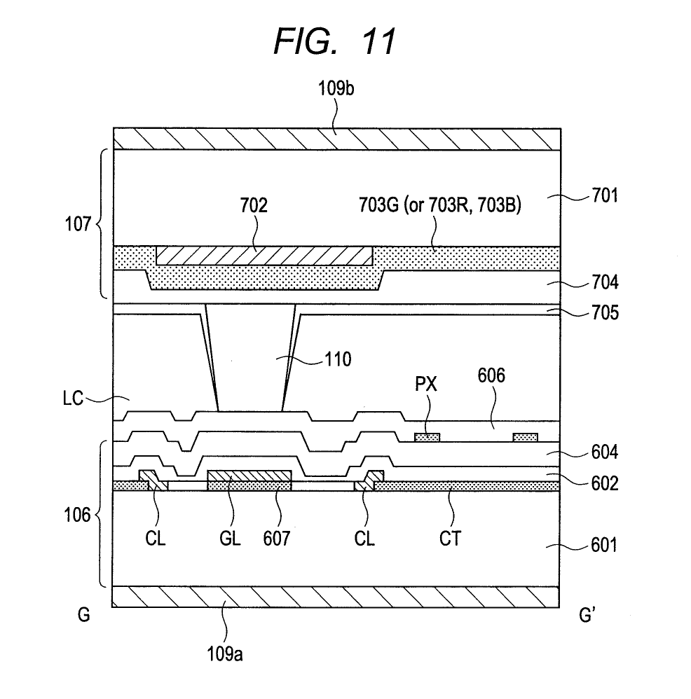

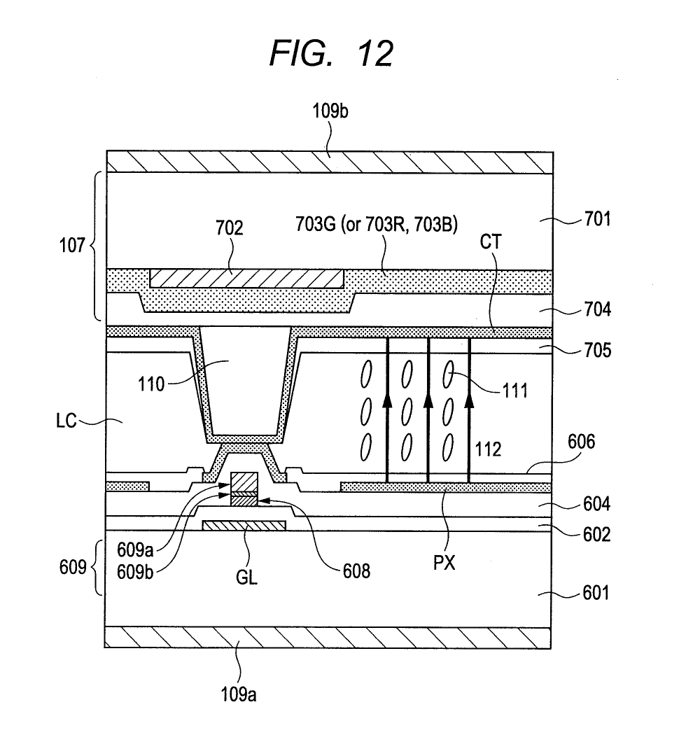

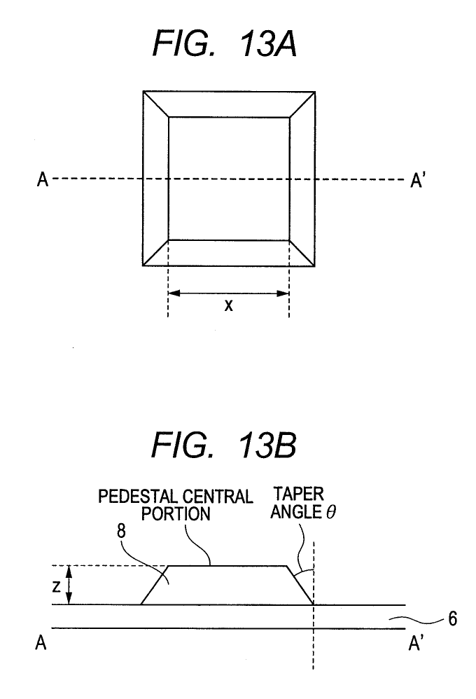

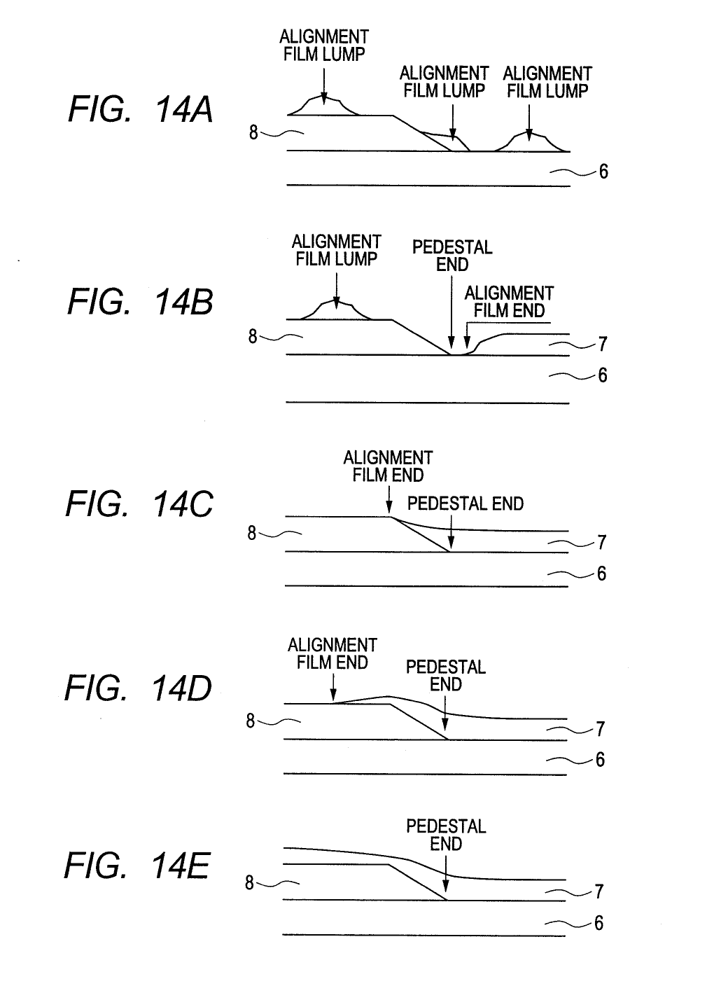

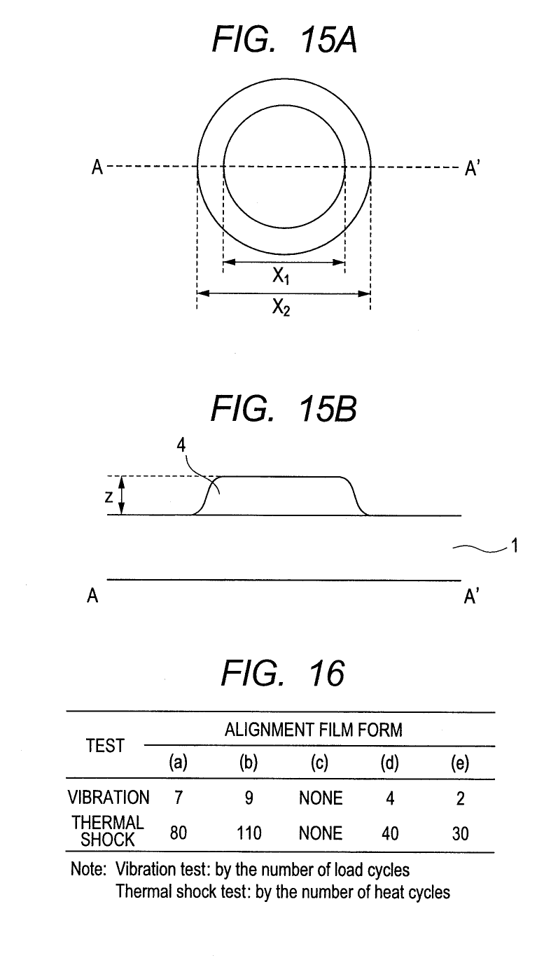

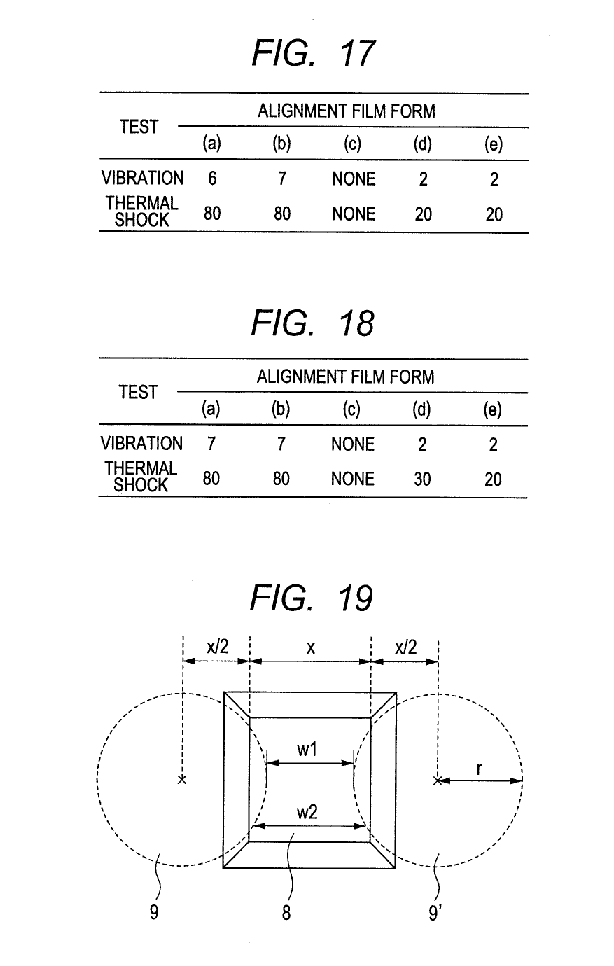

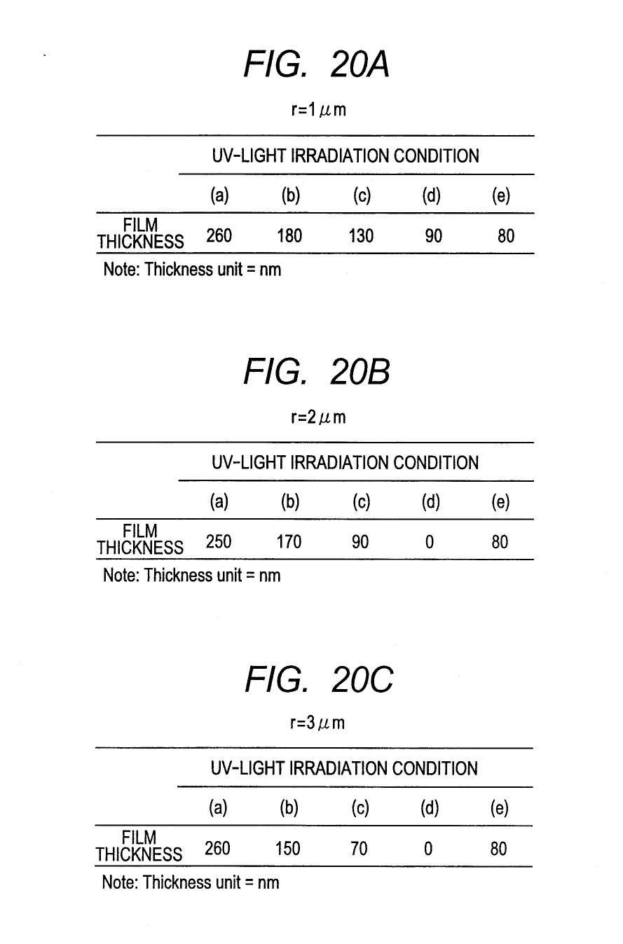

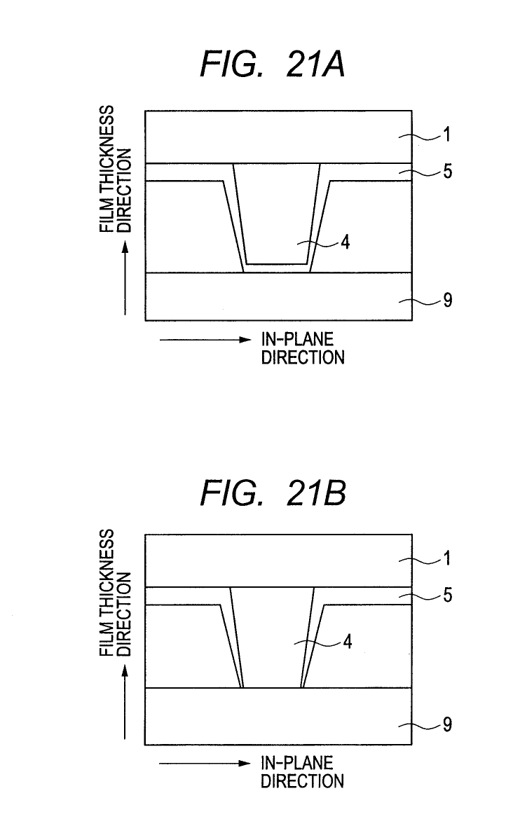

FIGS. 6 to 9 are schematic views showing an example of the configuration of the liquid crystal display device according to the invention. FIG. 6 is a schematic block diagram showing an example of the configuration of the liquid crystal display device according to the present invention. FIG. 7 is a schematic circuit diagram showing an example of the circuit configuration of one pixel in the liquid crystal panel. FIG. 8 is a schematic plan view showing an example of the configuration of the liquid crystal display panel. FIG. 9 is a schematic cross sectional view showing an example of the cross sectional configuration along the line A-A′ in FIG. 8.

The alignment film formed to have high quality by use of the alignment film formation solvent according to the invention is applied to, for example, active matrix liquid crystal display devices. The active matrix liquid crystal display device is used, for example, as a display (monitor) for portable electronic equipment, a display for personal computers, a display for printing or design, a display for medical equipment, and a liquid crystal television. The active matrix liquid crystal display device has, for example, a liquid crystal display panel 101, a first driving circuit 102, a second driving circuit 103, a control circuit 104, and a back light 105 as shown in FIG. 6.

The liquid crystal display panel 101 has a plurality of scanning signal lines GL (gate lines) and a plurality of video signal lines DL (drain lines). The video signal lines DL are connected to the second driving circuit 103. In FIG. 6, only part of the plurality of scanning signal lines GL is shown and in actual there are more scanning lines GL arranged densely in the liquid crystal display panel 101. Similarly, FIG. 6 shows only part of the plurality of video signal lines DL and in actual more video signal lines DL are arranged densely in the liquid crystal display panel 101.

Further, the display area DA of the liquid crystal display panel 101 is constituted by a large number of pixels, and an area occupied by one pixel in the display region DA corresponds to, for example, an area surrounded by adjacent two scanning signal lines GL and adjacent two video signal lines DL. In this case, the circuit of one pixel may be configured as shown in FIG. 7, including a TFT element Tr that functions as an active device, a pixel electrode PX, a common electrode CT (also called a counter electrode), and a liquid crystal layer LC. The liquid crystal display panel 1 includes, for example, a commonalizing interconnect CL is disposed so as to make the plurality of common electrodes CT of the pixels common.

An example of the structure of the liquid crystal display panel 101 is shown in FIGS. 8 and 9. Alignment films 606 and 705 are formed respectively on the surfaces of the active matrix substrate 106 and the counter substrate 107, and the liquid crystal layer LC (liquid crystal material) is disposed between the alignment films. Although not illustrated particularly, an intermediate layer (for example, optical intermediate layer such as a phase retardation plate, color conversion layer, and light diffusion layer) may be provided as appropriate between the alignment film 606 and the active matrix substrate 106, or between the alignment film 705 and the counter substrate 107.

The active matrix substrate 106 and the counter substrate 107 are bonded by a circular sealant 108 disposed around the outside of the display region DA, and the liquid crystal layer LC is sealed in the space surrounded by the alignment film 606 on the side of the active matrix substrate 106, the alignment film 705 on the side of the counter substrate 107, and the sealant 108. Further, when the liquid crystal display device is one that has a back light 105, the liquid crystal display panel 101 will have a pair of polarizing plates 109a and 109b disposed such that the two plates opposes with the active matrix substrate 106, the liquid crystal layer 106, and the counter substrate 107 therebetween.

The active matrix substrate 106 is made up of an insulation substrate such as a glass substrate with scanning signal lines GL, video signal lines DL, active elements (TFT elements Tr), pixel electrodes PX, etc. arranged thereon. When the driving system of the liquid crystal display panel 101 is a horizontal electric field driving system such as the IPS system, the common electrode CT and the commonalizing interconnect CL are disposed on the active matrix substrate 106. On the other hand, when the driving system of the liquid crystal display panel 101 is a vertical electric field driving system such as the TN system or VA (Vertical Alignment) system, the common electrode CT is disposed on the counter substrate 107. In the case of the vertical electric field driving type liquid crystal display panel 101, the common electrode CT is usually one large plate electrode that is shared by all pixels, and so the common interconnect CL is not provided.

Further, in the liquid crystal display devices concerning the present invention, a plurality of columnar spacers 110 for unifying the thickness of the liquid crystal layer LC in each of the pixels (also called a cell gap) are disposed in the space in which the liquid crystal LC is sealed. The plurality of columnar spacers 110 are disposed, for example, on the counter substrate 107.

The first driving circuit 102 is a driving circuit generating video signals (also called gradation voltage) which is applied by way of video signal lines DL to the pixel electrodes PX of the corresponding pixels, and such driving circuit is generally referred to as a source driver or a data driver. Further, the second driving circuit 103 is a driving circuit that generates scanning signals applied to the scanning signal lines GL, and such driving circuit is generally referred to as a gate driver or a scanning driver.

The control circuit 104 is a circuit for performing control such as controlling the operation of the first driving circuit 102 and the second driving circuit 103, and the luminance of the backlight 105, and such control circuit is generally referred to as a TFT controller or a timing controller. Further, the backlight 105 may be any of various light sources: for example, a fluorescent lamp such as a cold cathode fluorescent lamp or an emission diode (LED). Light emitted from the backlight 105 is converted into a planar light beam by a reflection plate, optical guide plate, optical diffusion plate, prism sheet, or the like not illustrated and applied to the liquid crystal display panel 101.

FIG. 10 is a schematic view showing an example of the configuration of an IPS liquid crystal display panel according to the present invention. In an active matrix substrate 106, scanning signal lines GL, a commonalizing interconnect CL, and a first insulation layer 602 covering the lines are formed over the surface of an insulation substrate such as a glass substrate 601.

Over the first insulation layer, a semiconductor layer 603 of a TFT element Tr, video signal lines DL, and pixel electrodes PX, and a second insulation layer 604 covering them are formed. The semiconductor layer 603 is disposed over the scanning signal line GL, and a portion of the scanning signal lines GL that is situated below the semiconductor layer 603 functions as the gate electrode for the TFT element Tr.

The semiconductor layer 603 is constituted by an active layer (channel forming layer) formed of first amorphous silicon, and a source diffusion layer and a drain diffusion layer stacked thereover formed of second amorphous silicon including an impurity of a different type and concentration from that the first amorphous silicon, for example. Further, a portion of the video signal line DL and a portion of the pixel electrode PX ride over the semiconductor layer 603 and the portions riding over the semiconductor layer 603 function as the drain electrode and the source electrode of the TFT element Tr.

Incidentally, the source and the drain of the TFT element Tr switches depending on the relation of the bias, that is, which potential is higher between the potential of the pixel electrode PX and that of the image signal line DL when the TFT element Tr is turned on. However, in the following description of the present specification, the electrode connected to the video signal DL is referred to as a drain electrode and the electrode connected to the pixel electrode is referred to as a source electrode.

A planarized third insulation layer 605 (overcoat layer) is formed over the second insulation layer 604. Common electrodes CT and an alignment film 606 covering the common electrodes CT and the third insulation layer 604 are formed over the third insulation layer 605. The common electrodes CT are coupled to the commonalizing interconnect CL by way of a contact hole CH (through hole) extending through the first insulation layer 602, the second insulation layer 604, and the third insulation layer 605.

Further, the common electrode CT is formed such that a gap Pg relative to the pixel electrode PX in a plan view is about 7 μm, for example. The alignment film 606 is coated with a polymeric material described with the following example and is subjected to a surface treatment for providing the surface with a liquid crystal alignment capability (e.g., rubbing treatment).

On the other hand, in the counter substrate 7, a black matrix 702 and color filters 703R, 703G, and 703B and a overcoat layer 704 covering them are formed over the surface of an insulation substrate such as a glass substrate 701. The black matrix 702 is, for example, a lattice-like light screening film for providing pixel unit opening areas over the display area DA. Further, the color filters 703R, 703G, and 703B are, for example, a film that passes only light within a specified wavelength range (color) among the white light emitted from the back light 105.

When the liquid crystal display device supports RGB type color display, a color filter 703R for transmitting a red light, a color filter 703G for transmitting a green light, and a color filter 703B for transmitting a blue light are disposed (a pixel of one color is representatively shown herein).

Further, the surface of the overcoat layer 704 is planarized. A plurality of columnar spacers 110 and an alignment film 705 are formed over the overcoat layer 704. The columnar spacers 110 have, for example, a conical trapezoidal shape with a flat top (also called a rotated trapezoid), and are formed at positions that correspond with parts of the scanning signal lines on the active matrix substrate 106 other than the parts where the scanning signal line GL and the TFT element Tr exist. Further, the alignment film 705 is formed, for example, of a polyimide resin, and is subjected to a surface treatment so as to provide the surface with liquid crystal alignment capability (e.g., rubbing treatment).

When the potential of the pixel electrodes PX and that of the common electrodes CT are equal and no electric field is applied, the liquid crystal molecules 111 in the liquid crystal display panel 101 of the type shown in FIG. 10 are aligned substantially parallel to the surface of the glass substrates 601 and 701, and oriented in the initial alignment direction defined by the rubbing treatment applied to the alignment films 606 and 705.

As the TFT elements Tr is turned on and the gradation voltages being applied to the video signal lines DL are written into the pixel electrodes PX, a potential difference is generated between the pixel electrode PX and the common electrode CT. Then, an electric field 112 (lines of electric force) as shown in FIG. 10 is generated and the electric field 112 with an intensity in accordance with the potential difference between the pixel electrode PX and the common electrode CT is applied to the liquid crystal molecules 111.

Since the liquid crystal molecules 111 forming the liquid crystal layer LC change their orientation to the direction of the electric field 112 by the interaction between the dielectric anisotropy of the liquid crystal layer LC and the electric field 112, the diffraction anisotropy of the liquid crystal layer LC changes. Further, the orientation of the liquid crystal molecules 111 at this time is determined by the intensity of the applied electric field 112 (magnitude of the potential difference between the pixel electrode PX and the common electrode CT). Accordingly, the liquid crystal display device can display video images or picture images by controlling the gradation voltage applied to the pixel electrode PX of each pixel while fixing the potential of the common electrode CT and changing the optical transmittance of each pixel.

FIG. 11 is a schematic view showing an example of the configuration of an FFS liquid crystal display panel according to the present invention. In an active matrix substrate 106, common electrodes CT, scanning signal lines GL, and a commonalizing interconnect CL, and a first insulation layer 602 covering them are formed over the surface of an insulation substrate such as a glass substrate 601. A semiconductor layer 603 of the TFT element Tr, video signal lines DL and source electrodes 607, and a second insulation layer 604 covering them are formed over the first insulation layer 602.

In this case, a portion of the video signal line DL and a portion of the source electrode 607 ride over the semiconductor layer 603, and the portion riding over the semiconductor layer 603 (here hidden in the depth direction and not illustrated) function as the drain electrode and the source electrode of the TFT element Tr. Further, in the liquid crystal display panel 1 of FIG. 11, the third insulation layer 605 is not formed and pixel electrodes PX and an alignment film 606 covering the pixel electrode PX are formed over the second insulation layer 604. The pixel electrodes PX are coupled to the source electrodes 607 by way of contact holes CH (through hole) passing through the second insulation layer 604.

In this case, a common electrode CT formed on the glass substrate 601 is formed in a plate-like form in an area surrounded by two adjacent scanning signal line GL and two adjacent video signal line DL (opening area). A pixel electrode PX having a plurality of slits is stacked over the planar common electrode CT. The common electrodes CT of the pixels arranged in the direction in which the scanning signal lines GL extend are made common by the commonalizing interconnect CL. On the other hand, the counter substrate 107 in the liquid crystal display panel 101 in FIG. 11 has the same configuration as that of the counter substrate 107 of the liquid crystal display panel 101 in FIG. 10. Detailed descriptions for the configuration of the counter substrate 107 are therefore omitted.

FIG. 12 is a schematic cross sectional view showing an example of the cross sectional configuration of the main portion of a VA liquid crystal display panel according to the invention. In a vertical electric field driving type liquid crystal display panel 101, as shown in FIG. 12, pixel electrodes PX are formed on an active matrix substrate 106 and a common electrode CT is formed on the counter substrate 107, for example. In the case of the VA liquid crystal display panel 101 which is one of the vertical electric field driving type panels, the pixel electrode PX and the common electrode CT are formed, for example, of a transparent conductor such as ITO in a simple planar form.

When no electric field applied and the potentials are equal between the pixel electrode PX and the common electrode CT, liquid crystal molecules 111 are oriented vertically to the surface of the glass substrates 601 and 701 by the alignment films 606 and 705. As potential difference is generated between the pixel electrode PX and the common electrode CT, an electric field 112 (line of electric force) substantially vertical to the glass substrates 601 and 701 is generated, and the liquid crystal molecules 111 are falls to a direction parallel to the substrates 601 and 701, whereby the polarization of incident light changes.

The orientation of the liquid crystal molecules 111 is determined depending on the intensity of the applied electric field 112. Thus, in the liquid crystal display device, video images or picture images are displayed by controlling the video signals (gradation voltage) applied to the pixel electrodes PX while fixing the potential of the common electrode CT, thereby changing the optical transmittance of each of the pixels.

There are various configurations for the configuration of the pixels in the VA liquid crystal display panel 101, for example, the planar shape of the TFT element Tr and the pixel electrode PX. The configuration of the pixels in a liquid crystal display panel 101 of the type shown in FIG. 12 can be any of such various configurations. Detailed descriptions for the configuration of the pixel in the liquid crystal display panel 101 are to be omitted.

The present invention concerns liquid crystal display panels 101 of the active matrix liquid crystal display device as described above, and particularly, concerns the configuration of the parts of the active matrix substrate 106 and the counter substrate 107 that contact with the liquid crystal layer LC, and also the peripheral portion of those parts. Therefore, detailed descriptions of the configuration of the first driving circuit 102, the second driving circuit 103, the control circuit 104 and the back light 105 having no direct relation with the invention are to be omitted.

To manufacture a liquid crystal display device according to this invention, various kinds of alignment film materials, alignment treatment methods, and liquid crystal materials, etc. that are conventionally used for liquid crystal display devices can be used, and it is also possible to apply various kinds of processes upon assembling components into a liquid crystal display device.

The present invention is to be described more specifically by way of embodiments, but the technical range of the invention is not limited to the following embodiments.

### Embodiment 1

At first, a receiving pedestal of an example of a liquid crystal display device according to the invention is to be described with reference to drawings and tables. Here, the examination results of when an IPS panel was manufactured are shown.

FIG. 13 shows the structure of a receiving pedestal examined in this embodiment. In this embodiment, a receiving pedestal having a square shape in a planer structure was manufactured. It is assumed that the length on one side of the central portion of the pedestal is x, the thickness thereof is z, and the angle between the normal of the substrate surface and the tapered portion of the pedestal is taper angle θ. Specifically, a substrate that has been processed up to a step where elements such as TFT circuits are provided and an insulation film 6 of SiN is formed over the second substrate 2.

MoCr of z=150 nm was deposited over the insulation layer and the MoCr layer was patterned by using a square photomask pattern of x=5 μm and a photoresist, as to form receiving pedestal at boundaries between pixel regions by using a liquid mixture of phosphoric acid, nitric acid, water as an etching solution. Further, a transparent electrode ITO was deposited thereover by 50 nm, and patterned such that it remains in the pixel regions although not illustrated by using an oxalic acid solution as an etching solution. In this step, ITO was not left over the patterned MoCr layer. The shape of the receiving pedestal thus obtained had a size of: x=4.4 μm and θ=60° under SEM observation.

Then, the surface of the substrate after formation of the structure was cleaned and irradiated with UV/ozone to clean the surface. Then, a fluoro silane coupling agent trichloro(1H,1H,2H,2H-heptadecafluorodecyl)silane solution manufactured by Tokyo Ohka Kogyo Co. was coated, and after excess solution was removed by rinsing, the substrate was dried. After arranging a square photomask pattern of x=4.5 μm, UV-light was irradiated in an atmospheric air to remove the silane coupling agent on the region not covered by the photomask. As a reference, a sample that was not subjected to the treatment using the silane coupling agent and the photomask was also manufactured.

A polyamide acid solution having a cyclobutane diamine skeleton was coated thereover by screen printing. The solvent was temporarily evaporated in a furnace at 70° C. for 10 min and then imidized by baking in a furnace at 220° C. for 10 min. Then, the substrate was irradiated with polarized UV light at a room temperature and post baked in a furnace at 230° C. for 20 min to form a second alignment film 7. The film thickness of the finished second alignment film 7 was 100 nm at the pixel flat portion.

The form and the film thickness distribution of the obtained second alignment film 7 were observed under cross sectional SEM observation. FIG. 14 shows schematic views of the cross sectional forms of typical second alignment films 7. It was found that the alignment film 7 shows various forms depending on the conditions of UV-light irradiation performed via the photomask after the silane coupling agent was coated. For example, when the UV-light is excessively weak, the alignment film was deposited here and there in lumps over the entire surface of the receiving pedestal as shown in FIG. 14A. The film thickness of this area was random, and at some parts, the thickness was over the thickness of the reference film.

When the UV-light irradiation condition was somewhat increased, while the film over the planar portion outside the receiving pedestal was uniform, lumps remained in the upper portion and the edge portion of the receiving pedestal as shown in FIG. 14B. When the UV-light irradiation condition was further intensified, the alignment film did not remain over the upper surface of the pedestal, and the film end begins just from the end of the upper surface of the pedestal as shown in FIG. 14C. When the UV-light irradiation condition was slightly further intensified, it took a form such that the alignment film end begins from the upper portion of the pedestal as shown in FIG. 14D. Incidentally, in the reference film, the film was in a continuous form and had somewhat small thickness of 80 nm at the upper portion of the pedestal as shown in FIG. 14E. The alignment film forms are hereafter referred to as (A) to (E) using the symbols in FIG. 14A to 14E.

On the other hand, the columnar spacer 4 on the first substrate 1 was designed as a cylindrical structure comprising a photocurable resin having a thickness: z=4.2 μm, upper diameter: x₁=16 μm and lower diameter: x₂=20 μm, as schematically shown in FIG. 15. When the first alignment film 5 is formed thereover, a state in which the alignment film is scarcely deposited on the upper diametrical region could be achieved by optimizing the process conditions (that is, the alignment film was not observed under SEM observation, but a signal from nitrogen atoms which is derived from alignment film was detected slightly by EDX, and the estimated film thickness was 1 to 2 nm). Such upper and lower substrates were assembled to form cells, and the composed liquid crystal display device was tested to examine the life of the alignment film by the following two methods.

One of the two is a vibration test. That is, with the liquid crystal display device is fixed to a vibrational testing apparatus, the liquid crystal display panel was vibrated by moving the vibrational testing apparatus in the out-of-plane direction of the liquid crystal display device (for example in the direction vertical to the surface of glass substrates 601 and 710 in the IPS panel). For example, to reproduce vibrations assumed to be generated during transportation of the liquid crystal display device, sinusoidal vibrations in which the number of vibrations was modulated (put to sweeping) from 50 Hz to 100 Hz in 5 min was applied at an acceleration of 1.0 G for 30 minutes.

The liquid crystal display device after application of the vibrations was observed microscopically without applying an electric field. Whether there is any light spot due to alignment disturbance in the pixel which is expected to be kept originally in a uniform black display was observed, and when a light spot did not exist, it was evaluated as good, and a failure when a light spot existed. When it was evaluated as good, vibrations were again applied and observation was performed in the same manner for another 30 min. When it was evaluated as a failure, the test was terminated at the instance and the number of applied vibrations at that instance was defined as its life in the vibrational test. When the sample was kept with no failure up to 100 cycles of the applied number of vibrations, it was defined to have no light spot.

The other is a thermal shock test. That is, the liquid crystal display device was kept in a thermostable bath capable of periodically changing the temperature. In this test, the temperature was altered within a range of upper limit temperature of 85° C. and lower limit temperature of −30° C. with one cycle set as one hour.

After 10 cycles, the liquid crystal display device was once taken out from the thermostable bath, observed microscopically without applying an electric field and observed whether any light spot exists or not due to alignment disturbance in the pixel, which is expected to be kept in a uniform black display originally. It was evaluated as good when the light spot was not present, and evaluated as failure when the light spot was present. When it was estimated as good, the process was conducted again in the thermostable bath in the same manner for 10 cycles. When it was estimated as failure, the test was terminated at the instance and the number of cycles at that instance was defined as its life in this test. When the sample remained with no failure up to 1000 cycles, it was evaluated to have no light spot.

Table 1 shown in FIG. 16 shows the result of the test. Table 1 shows the test result of the IPS panel. The state of the generation of light spots was different depending on the alignment film forms (A) to (E). In the forms where alignment film remained over the receiving pedestal 8, light spot was generated at an early stage. The form which had completely no micro light spot was the form (C), in which it could be reliably assured that the alignment film did not remain over the pedestal 8.

An FFS panel was manufactured by the same procedures but properly changing the alignment film material or the liquid crystal material, and the similar life test was conducted. The result is shown in Table 2 of FIG. 17. In the same manner as in Table 1, the state of generating the light spot was different depending on the forms (A) to (E) of the edge of the alignment film. Light spots were generated in an early stage in the forms where alignment film remained over the receiving pedestal 8.

A VA panel was manufactured by the same procedures while properly changing the alignment film material and the liquid crystal material, and the similar life test was conducted. The result is shown in Table 3 of FIG. 18. In the same manner as in Table 1, the state of generating the light spot was different depending on the forms (A) to (E) of edge of the alignment film. Light spots were generated in an early stage in the forms where alignment film remained over the receiving pedestal 8.

As described above, it was confirmed that the generation of micro light spots can be suppressed in a liquid crystal display device, as the one according to the present invention, in which the alignment film is not formed at the central portions of the receiving pedestals, and at the outer periphery of the receiving pedestal, the alignment film has an inclined thickness distribution such that the thickness thereof is increased gradually from the central portion to the outside.

### Embodiment 2

Next, an example of a receiving pedestal of another embodiment of a liquid crystal display device of the invention is to be described with reference to the drawing and the table. FIG. 19 shows the layout of a receiving pedestal and light shielding portions of photomasks for partially providing liquid repellency used in Embodiment 2. The receiving pedestal is identical with that of the Embodiment 1, and the same silane coupling agent for providing liquid repellency was coated. However, the pattern of the photomask for partially removing the silane coupling agent was changed from the square shape in the Embodiment 1 to the photomask light shielding regions 9 and 9′ indicated by the two circles.

That is, while the liquid repellent pattern in the Embodiment 1 was such that no polyamide acid solution of the alignment film would be deposited over the central portion of the receiving pedestal, the Embodiment 2 is characteristic in that the pattern is such that the central portion would not be provided with liquid repellency whereas the peripheral portion is rendered liquid repellent.

The length x of one side of the square of the receiving pedestal was 4.4 μm, and the light shielding region of the photomask was selected such that the center thereof was positioned outside by x/2, and the radius r of the circle was 1, 2, and 3 μm. The UV-ray irradiation dose after coating of the silane coupling agent was identical with the irradiation dose used in the Embodiment 1 for obtaining the alignment film forms (A) to (E) and corresponding symbols are used respectively.

Table 4 shown in FIG. 20 shows the thickness of the alignment film read from a cross sectional SEM image at the central portion of the receiving pedestal 8 (greatest thickness in cases where the distribution has an island-like form). The reference is such that, as with Embodiment 1, the treatment using the silane coupling agent was not applied. In this embodiment, the silane coupling agent remains on the surface to provide a liquid repellent surface when the UV-light irradiation is not applied after the treatment by the silane coupling agent. As the UV-ray irradiation dose increases, the silane coupling agent was decomposed and removed to modify the surface to a lyophilic property.

Accordingly, when the UV-light is irradiated sufficiently, it is expected that a uniform alignment film layer should be formed over the receiving pedestal 8. As expected, it was found that while the thickness approached gradually to the thickness (E) of the reference when r=1 μm, the thickness decreased to less than that of the reference when r=2 μm and 3 μm, and the alignment film did not remain under the condition (D).

That is, when the region increases as w1→w2 toward the periphery of the hydrophilic region, the hydrophilic liquid crystal display device moves to the outside and, as a result, the alignment film does not remain at the central portion of the pedestal.

In view of the above, it was confirmed in the liquid crystal display device of the invention that a state where the alignment film was not formed could be attained at a position for the central portion of the receiving pedestal by disposing the region having the inclined thickness distribution of the second alignment film has a distribution within the plane of the substrate.

### Embodiment 3

FIG. 21 shows an example of another embodiment near the columnar spacer of the invention. While the receiving pedestal 8 was disposed at a position opposing the columnar spacer 4 in the previous embodiments, it is also possible to form a structure of receiving the columnar spacer by not disposing a special receiving pedestal 8 but utilizing already formed members, for example, members such as a transparent electrode, a gate interconnect, a video signal line, a planarizing film, etc.

In the second substrate, the second alignment film 7 does not exist at a position in contact with the columnar spacer 4. A method of forming a portion where the second alignment film 7 is not present includes: for example, (1) a method of patterning a fluoro alkyl silane; (2) a method of patterning a silane coupling agent by UV-light or the like; and (3) a method of using oxygen plasma or CF₄ plasma.

A transparent conductive film may be present or an insulation layer may be present at a portion directly in contact with the columnar spacer 4. In this embodiment, such a member is shown as a columnar spacer opposing position surface 9. The columnar spacer opposing position surface 9 may not necessarily be a convex structure as in the receiving pedestal but may be a simple flat surface.

The columnar spacer opposing position surface 9 has an area larger than that at the top end of the columnar spacer 4. While a second alignment film 7 is present at the periphery of the columnar spacer opposing position surface 9, the second alignment film 7 has an inclined thickness distribution where the thickness increases gradually from the periphery to the outside of the columnar spacer opposing position surface 9.

Further, the second alignment film 7 sometimes has a distribution of the thickness in the direction of the plane at the periphery of the columnar spacer opposing position surface 9.

Alternatively, as shown in FIG. 19, it is possible to use a method of removing the second alignment film 7 from the columnar spacer opposing position surface 9 by forming a liquid repellent region on both sides of the columnar spacer opposing position surface 9 and enlarging the hydrophilic region from the central portion to the periphery of the columnar spacer opposing position surface 9.

While FIG. 19 shows a case where the pedestal is present, it is possible not to form the second alignment film 7 to the columnar spacer opposing position surface 9 by using the same principle also in a case where the pedestal is not present as in this embodiment. That is, in a case where the receiving pedestal is not disposed particularly, it is possible to exclude the presence of the alignment film to the columnar spacer opposing position surface 9 by selectively using the hydrophilic region and the liquid repellent region.

This embodiment includes a case where the first alignment film 5 remains at the portion in contact with the opposing position surface over the columnar spacer as shown in FIG. 21A and a case where it does not remain as shown in FIG. 21B. It is preferred that the alignment film does not remain as shown in FIG. 21B and it is also possible to avoid the deposition of the alignment film over the columnar spacer by the same means for attaining such a state. In a most preferred state, the alignment film is deposited neither on the columnar spacer nor on the opposing position surface. Possibility of causing generation of obstacles and display failure is increased due to film scraping along with increase in the deposition amount.

In the foregoing description, while the term “hydrophilic” is used, this term means the contrary of “liquid repellent” and may be replaced with the term “lyophilic”.

What is claimed is:

1. A liquid crystal display device comprising: a first substrate; a second substrate disposed in facing relation to the first substrate; a liquid crystal material disposed between the first substrate and the second substrate; a plurality of columnar spacers and a first alignment film disposed over the first substrate; an insulation film disposed over the second substrate; and a second alignment film disposed over the insulation layer; the liquid crystal display device further comprising:
receiving pedestals for the columnar spacers, the receiving pedestals being disposed between the insulation layer and the liquid crystal material at positions where the receiving pedestals face the columnar spacers, the receiving materials each being formed of a material different from those for the insulation layer and the second alignment film, wherein:
the second alignment film is not formed over the central portion of each of the receiving pedestals; and
around the outer peripheral portion of each receiving pedestal, the second alignment film has an inclined thickness distribution which is such that the thickness thereof increases gradually from the central portion to the outside position of the receiving pedestal.

2. A liquid crystal display device according to claim 1, wherein the first alignment film is not formed over the central portion of each of the columnar spacers disposed on the first substrate; and
around the outer peripheral portion of each of the columnar spacers, the first alignment film has an inclined thickness distribution such that the thickness thereof gradually increases from the central portion to the outside of the receiving pedestal.

3. A liquid crystal display device according to claim 1, wherein the area of the second alignment film having the inclined thickness distribution is formed over part of the substrate plane.

4. A liquid crystal display device according to claim 3, wherein the area of the second alignment film having the inclined thickness distribution has a shape that gets smaller toward the central portion of the receiving pedestal and gets larger toward the outer peripheral direction of the receiving pedestal.

5. A liquid crystal display device according to claim 1, wherein the area of the second alignment film having the thickness inclined distribution is formed over a recessed portion of the receiving pedestal.

6. A liquid crystal display device according to claim 1, wherein the planar shape of the receiving pedestals is circular or elliptic.

7. A liquid crystal display device according to claim 1, wherein the receiving pedestals have a liner shape.

8. A liquid crystal display device according to claim 1, wherein the receiving pedestals are formed of a transparent conductive film.

9. A liquid crystal display device according to claim 1, wherein the receiving pedestals are formed of ITO (Indium-Tin Oxide).

10. A liquid crystal display device according to claim 1, wherein the receiving pedestals are formed of a metal thin film containing one of Al, Cu, Ag, Cr, Mo, Ni, and W.

11. A liquid crystal display device according to claim 8, wherein a silane coupling agent is coated on the surface of the receiving pedestal.

12. A liquid crystal display device according to claim 8, wherein the surface of the receiving pedestal is subjected to plasma treatment.

13. A liquid crystal display device according to claim 1, wherein the receiving pedestal comprises a fluorine-containing polymer.

14. A liquid crystal display device according to claim 1, wherein the contact angle with water of the central portion of the receiving pedestal is larger than that of the second alignment film formed around the outer peripheral portion of the receiving pedestal.

15. A liquid crystal display device according to claim 1, wherein the area in which the second alignment film is not formed extends as far as the outside of the receiving pedestal.

16. A liquid crystal display device comprising: a first substrate; a second substrate disposed in facing relation to the first substrate; a liquid crystal material disposed between the first substrate and the second substrate; a plurality of columnar spacers and a first alignment film disposed over the first substrate; an insulation layer disposed over the second substrate; and a second alignment film disposed over the insulation layer; wherein:
the second alignment film is not formed at portions of the second substrate opposing the columnar spacers;
the area of the portions opposing the columnar spacers is larger than the area of the top ends of the columnar spacers;
the second alignment film around the periphery of the opposing portion has an inclined thickness distribution such that the thickness of the film increases gradually toward the outside direction; and
the second alignment film around the periphery of the opposing portion has a thickness distribution also in the in-plane direction of the substrate.

17. A liquid crystal display device according to claim 16, wherein the first alignment film is not formed at the central portions of the columnar spacers disposed on the first substrate.

18. A liquid crystal display device according to claim 16, wherein the portions opposing the columnar spacers are the insulation layer.

19. A liquid crystal display device according to claim 16, wherein the portions opposing the columnar spacers are a transparent conductive film.
